(19) United States
(12) Patent Application Publication
(10) Pub. No.: US 2012/0243024 A1
(43) Pub. Date: Sep. 27, 2012

(54) Information Processing Devices and Information Processing Processes

(75) Inventor: Yuji MIYATA, Kitanagoya-shi (JP)

(73) Assignee: BROTHER KOGYO KABUSHIKI KAISHA, Nagoya-shi (JP)

(21) Appl. No.: 13/428,814

(22) Filed: Mar. 23, 2012

(30) Foreign Application Priority Data
Mar. 25, 2011 (JP) 2011-069004

(51) Int. Cl. G06K 15/02

(52) U.S. Cl. 358/1.13

(57) ABSTRACT

An image processing device includes a preview function including specifying a setting related to printing, generating a first processed image by using a target file by performing image processing corresponding to the specified setting, storing the generated first processed image, displaying the first processed image, and displaying, when the setting is changed, a second processed image that is generated from image processing of the first processed image and corresponds to the changed setting.

### CROSS REFERENCE TO RELATED APPLICATION

This application claims priority from Japanese Patent Application No. 2011-069004, filed on Mar. 25, 2011, the entire subject matter of which is incorporated herein by reference.

### TECHNICAL FIELD

One or more aspects of the invention relate to information processing devices and information processing processes.

### BACKGROUND

A known print preview function is to generate and display a print image (a preview image), which is to be printed with a current print setting, to allow a user to confirm the print image before actual printing is performed.

### SUMMARY

In the known print preview function, when the user changes the printer setting to confirm various preview images, it takes a time to generate an updated preview image because the updated preview image is generated by using data to be printed every time the user changes the printer setting. Therefore, the user needs to wait until an updated preview image corresponding to the changed print setting appears on a screen when the user changes the print setting. When the data to be printed includes a plurality of pages of data or when a computer that is used to generate a preview image has lower processing performance, the user needs to wait more time until the preview image appears on the screen.

Embodiments provide for information processing devices and information processing processes for immediately displaying a processed image corresponding to settings related to printing when the setting is changed.

An image processing device may include a processor, and a memory storing computer readable instructions that, when executed, cause the image processing device to perform functions comprising specifying a setting related to printing, generating a first processed image by using a target file by performing image processing corresponding to the specified setting, storing the first processed image, displaying the first processed image, displaying, when the setting is changed, a second processed image that is generated from image processing of the first processed image and corresponds to the changed setting.

A non-transitory, computer-readable medium may store an information processing program that, when executed by a processor, causes an information processing device to execute a step of specifying a setting related to printing, a step of generating a first processed image by using a target file by performing image processing corresponding to the specified setting, a step of storing the first processed image, a step of displaying the first processed image, a step of displaying, when the setting is changed, a second processed image that is generated from image processing of the first processed image and corresponds to the changed setting.

An information processing method to be executed in an image forming device may include a step of specifying a setting related to printing, a step of generating a first processed image by using a target file by performing image processing corresponding to the specified setting, a step of storing the first processed image, a step of displaying the first processed image a step of displaying, when the setting is changed, a second processed image that is generated from image processing of the first processed image and corresponds to the changed setting.

According to one or more aspects of the invention, when the setting related to printing is changed, the image processing device displays the second processed image corresponding to the changed setting by using the first processed image. Therefore, the image processing device can immediately display the second processed image corresponding to the changed settings as compared with an image processing device configured to generate and display a processed image by using a target file.

### BRIEF DESCRIPTION OF THE DRAWINGS

Illustrative aspects will be described in detail with reference to the following figures in which like elements are labeled with like numbers and in which:

FIG. 1 is a block diagram showing an electric configuration of a mobile terminal equipped with a device control application in a first embodiment of the invention according to one or more aspects of the invention;

FIG. 2 illustrates an illustrative setting screen to be displayed in the mobile terminal in the first embodiment according to one or more aspects of the invention;

FIG. 3 illustrates an illustrative preview screen to be displayed in the mobile terminal in the first embodiment according to one or more aspects of the invention;

FIG. 4 is a flowchart of a printing process in the first embodiment according to one or more aspects of the invention; and

FIG. 5 is a flowchart of a printing process in a second embodiment according to one or more aspects of the invention.

### DETAILED DESCRIPTION

It is noted that various connections are set forth between elements in the following description. It is noted that these connections in general and, unless specified otherwise, may be direct or indirect and that this specification is not intended to be limiting in this respect.

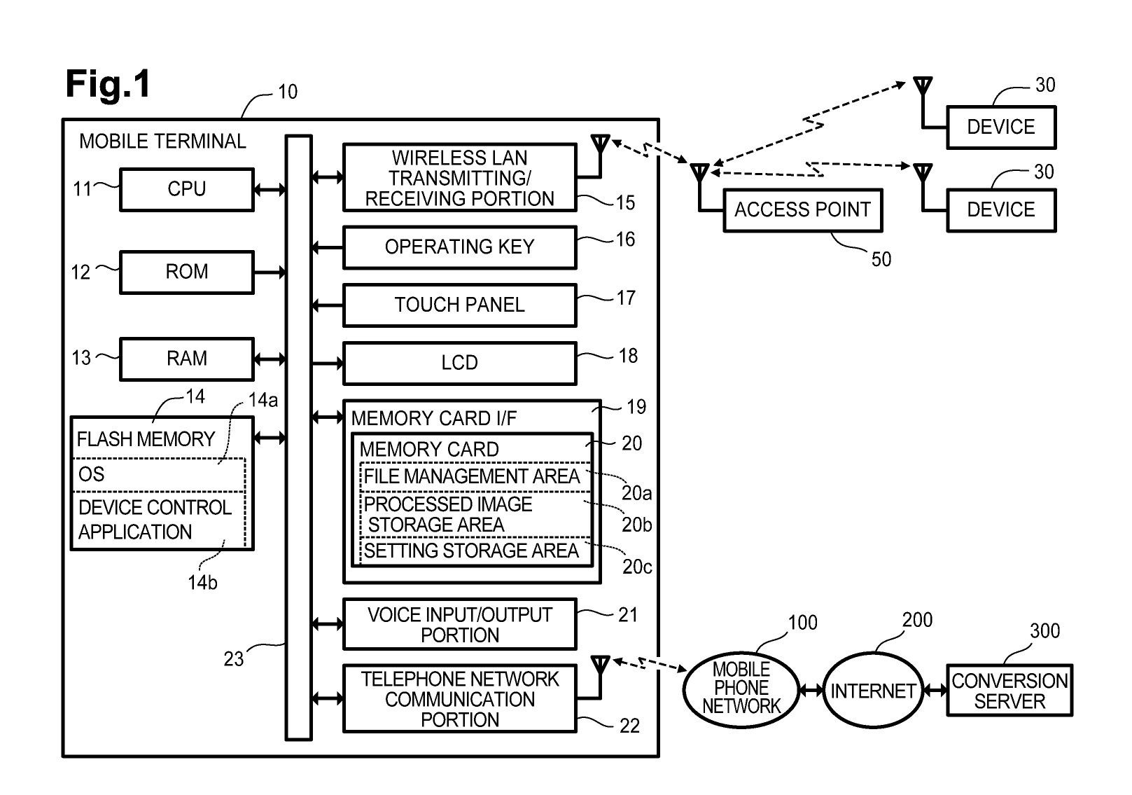

Embodiments will be described in detail with reference to the accompanying drawings. As shown in FIG. 1, a mobile terminal 10 is equipped with a device control application 14b according to an embodiment of the invention. The device control application 14b is configured to allow the mobile terminal 10 to perform one or more of a printing function and a scanning function of a device 30 directly by bypassing, for example, a personal computer. In particular, the device control application 14b is configured to allow a liquid crystal display unit (LCD) 18 to display a preview image for printing. When setting related to printing is changed, the device control application 14b is configured to immediately display an updated preview image corresponding to the changed setting on the LCD 18.

The mobile terminal 10 is, for example, a mobile phone that is configured to perform voice communication with another device and to access to the Internet 200, via a mobile phone network 100. The mobile terminal 10 is configured to perform wireless communication with the device 30 by using an infrastructure mode via an access point 50. The mobile terminal 10 comprises a central processing unit (CPU) 11, a read-only memory (ROM) 12, a random-access memory (RAM) 13, a flash memory 14, a wireless local-area network (LAN) transmitting/receiving portion 15, an operating key 16, a touch panel 17, the LCD 18, a memory card interface (I/F) 19, a voice input/output portion 21, and a telephone network communication portion 22, which are connected with each other via a bus line 23.

The CPU 11 is configured to control each component or portion connected with the bus line 23, in accordance with fixed values and programs stored in the ROM 12, for example. The ROM 12 is non-modifiable nonvolatile memory. The RAM 13 is a rewritable nonvolatile memory.

The flash memory 14 is a rewritable nonvolatile memory and is configured to store an operating system (OS) 14a and the device control application 14b. The OS 14a is basic software for implementing standard functions of the mobile terminal 10. In this embodiment, the ANDRIOD® operating system is applied to the OS 14a (ANDROID is a trademark of the Google, Inc.). The device control application 14b is provided by a vendor of the device 30, for example, and is installed on the mobile terminal 10 by a user. The device control application 14b is configured to allow the user to access the device 30 from the mobile terminal 10. Hereinafter, the CPU 11 that executes the programs, such as the applications and OS, may be also simply referred to as a program name. For example, the application may refer to the CPU 11 that executes the application.

Each of the applications (including the device control application 14b) installed on the mobile terminal 10 is configured to call an Application Program Interface (API) of the OS 14a and to output, to the OS 14a, data, which is intended to pass to each comportment or portion of the mobile terminal 10, for example, the wireless LAN transmitting/receiving portion 15, the operating key 16, the touch panel 17, the LCD 18, the memory card I/F19, the voice input/output portion 21, and the telephone network communication portion 22. That is, each of the applications is configured to control each component or portion of the mobile terminal 10 by calling the API of the OS 14a. Further, each of the applications is configured to obtain data indicating a status of each component or portion (including data indicating an input status into the mobile terminal 10) by calling the API of the OS 14a. The OS 14a may provide each of the applications with data outputted by each component or portion of the mobile terminal 10 and data indicating a status of each component or portion periodically or every time the status of each component or portion changes. That is, each of the applications is configured to obtain the data indicating the status of each component or portion (including the data indicating the input status into the mobile terminal 10) from the OS 14a by receiving the data from the OS 14a.

The wireless LAN transmitting/receiving portion 15 is a circuit configured to join a wireless network to establish one or more connections between the mobile terminal 10 and other device on a wireless LAN. The wireless network may conform to the standard IEEE802.11b/g (i.e., a WI-FI network (WI-FI is a trademark of the Wi-Fi Alliance)). Wireless communication between the mobile terminal 10 and the access point 50 is enabled by the wireless LAN transmitting/receiving portion 15.

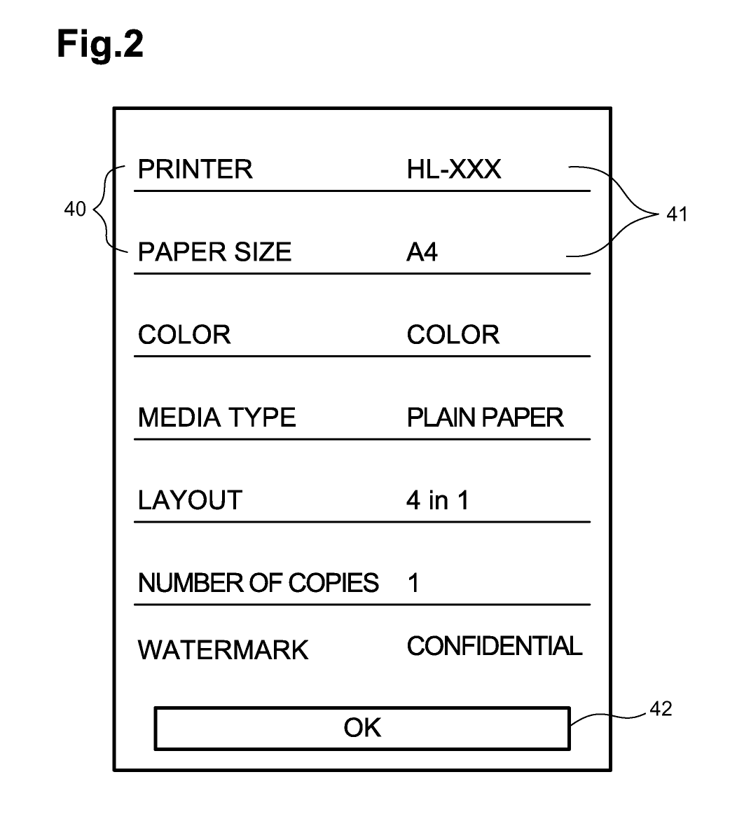

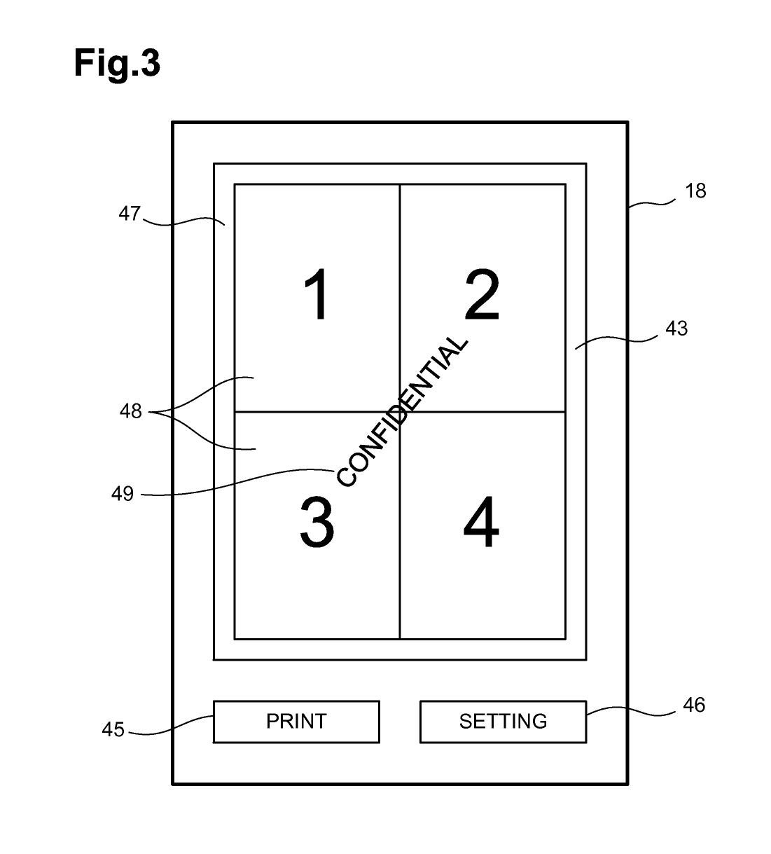

The operating key 16 is a mechanical key provided on a casing of the mobile terminal 10. The operating key 16 is configured to allow the user to input setting information or instructions into the mobile terminal 10. The touch panel 17 is disposed on the LCD 18. The touch panel 17 is configured to allow the user to input setting information or instructions into the mobile terminal 10. The LCD 18 is configured to display, for example, a setting screen (described later with reference to FIG. 2) and a preview screen (described later with reference to FIG. 3). The memory card I/F 19 is configured to accept a nonvolatile memory card 20 and to control a read and write of data into the memory card 20.

The memory card 20 is, for example, an SD-type memory card. In this embodiment, the memory card 20 comprises a file management area 20a, a processed image storage area 20b, and a setting storage area 20c. The file management area 20a is configured to store, for example, a file downloaded from the Internet 200, an attached file received through an e-mail, and a file generated from scanned data obtained from the device 30. The processed image storage area 20b is configured to store a processed image generated by which image processing is performed onto an image to be printed. The setting storage area 20c is configured to store settings related to printing. The device control application 14b is configured to store a processed image into the processed image storage area 20b by calling the API of the OS 14a to request the OS 14a for the storing of the processed image. Similar to this, the device control application 14b is configured to store settings into the setting storage area 20c by calling the API of the OS 14a for the storing of the settings.

The voice input/output portion 21 is a voice input/output device comprising a microphone and a speaker, for example. The telephone network communication portion 22 is a circuit for performing communication via the mobile phone network 100. The mobile phone network 100 is, for example, a communication network in International Mobile Telecommunication 2000 (IMT-2000), and is configured to allow the mobile terminal 10 to access the Internet 200 via a gateway (not shown). A conversion server 300 is configured to convert files in various formats uploaded by the mobile terminal 10 into JPEG format that can be processed in the mobile terminal 10, and to provide the converted files back to the mobile terminal 10.

The device 30 is a multifunction peripheral device having a printing function, a scanning function, and a copying function, for example. The device 30 comprises a wireless LAN transmitting/receiving portion (not shown) that has the same configuration as the wireless LAN transmitting/receiving portion 15 of the mobile terminal 10. The device 30 is configured to join the wireless network through the wireless communication via the access point 50 and to establish a wireless connection with the mobile terminal 10, thereby permitting the device 30 to print an image based on data sent from the mobile terminal 10.

One or more devices 30 with which the mobile terminal 10 is communicable may be present in the environment. In this embodiment, the mobile terminal 10 can communicate with two devices 30 via the access point 50. One of the devices 30 is an inkjet printer configured to print an image by an inkjet printing method and another of the devices 30 is a laser printer configured to print an image by an electrophotographic printing method.

Referring to FIG. 2, an illustrative setting screen to be displayed on the LCD 18 by the device control application 14b will be described. The setting screen comprises setting items 40 related to printing, settings 41 specified in the respective setting items 40, and an “OK” button 42.

The setting items 40 comprise PRINTER, PAPER SIZE, COLOR, MEDIA TYPE, LAYOUT, NUMBER OF COPIES, and WATERMARK.

PRINTER specifies a model of a device 30 to which a print instruction is to be provided. PAPER SIZE specifies a size of a sheet on which an image to be printed. COLOR specifies print color, whether an image is to be printed in color or in monochrome (grayscale). MEDIA TYPE specifies a type of a sheet on which an image to be printed. LAYOUT specifies the number of pages to be printed per sheet. A case where N pages of images are to be printed per sheet is referred to as N-in-1 (one) printing (where N is an integer of one or greater). NUMBER OF COPIES specifies the number of copies to be produced. WATERMARK specifies a watermark image, e.g., a text string, to be printed together with an image.

The device control application 14b is configured to accept the change of one or more of the settings 41 by the user while displaying the setting screen on the LCD 18. More specifically, when one of the setting items 40 specified on the setting screen is touched by the user, the device control application 14b is configured to display a list of options which can be specified with respect to the selected setting item 40. When the user selected a desired option from the list, the device control application 14b is configured to specify and display the selected option as the setting 41 of the selected setting item 40 on the setting screen.

When the “OK” button 42 on the setting screen is touched by the user, the device control application 14b is configured to change the screen display from the setting screen to a preview screen (See FIG. 3) on the LCD 18. The settings 41 displayed on the setting screen after the user touched the “OK” button 42 are referred to as the current settings 41. The device control application 14b is configured to display a preview image corresponding to the current settings 41 on the preview screen of the LCD 18.

With reference to FIG. 3, an illustrative preview screen to be displayed on the LCD 18 by the device control application 14b will be described below. The preview screen comprises a preview image 43, a “PRINT” button 45, and a “SETTING” button 46. The preview image 43 comprises a margin 47, one or more page images 48, and a watermark 49.

The margin 47 is white space formed around edges of a sheet when an image is printed on the sheet by the device 30 specified in the current setting 41 of PRINTER. In the first embodiment, when one of the devices 30, which is the laser printer, is specified in the current setting 41 of PRINTER, the device control application 14b is configured to display a preview image 43 with a margin 47. When another of the devices 30, which is the inkjet printer, is specified in the current setting 41 of PRINTER, the device control application 14b is configured to display a preview image 43 with no margin 47. This is because most of the inkjet printers can perform borderless printing in which white space is not formed around edges of a sheet.

The page image 48 represents one page of an image. In the first embodiment, when N-in-1 printing is specified in the current setting 41 of LAYOUT, the device control application 14b is configured to display a preview image 43 including N pages of page images 48. When color printing is specified in the current setting 41 of COLOR, the device control application 14b is configured to display each of the page images 48 in full color. When monochrome printing is specified in the current setting 41 of COLOR, the device control application 14b is configured to display each of the page images 48 in monochrome.

The watermark 49 comprises a watermark image, e.g., a text string, to be printed in a light color in the background of the page image 48. In the first embodiment, a watermark of a text string specified in the current setting 41 of WATERMARK is displayed as the watermark 49. When the current setting 41 of WATERMARK is off, the device control application 14b is configured to display a preview image 43 with no watermark 49.

Through the display of the preview image 43, the user can determine an image corresponding to the current settings 41, prior to actual printing performed by the selected device 30. When the “PRINT” button 45 on the preview screen is touched by the user, the device control application 14b is configured to provide the selected device 30 with an instruction to print a processed image, on which the image processing has been performed based on the current settings 41. When the “SETTING” button 46 on the preview screen is touched by the user, the device control application 14b is configured to change the screen display from the preview screen to the setting screen (See FIG. 2) on the LCD 18 and to accept the change of one or more of the settings 41.

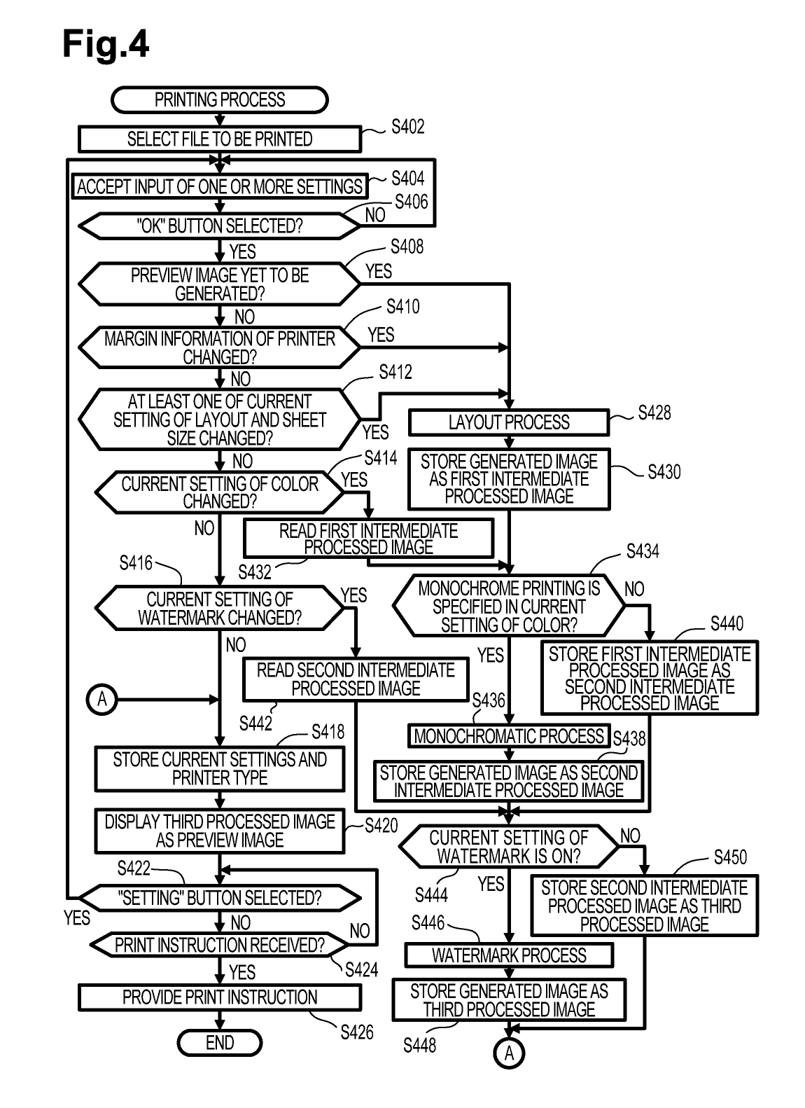

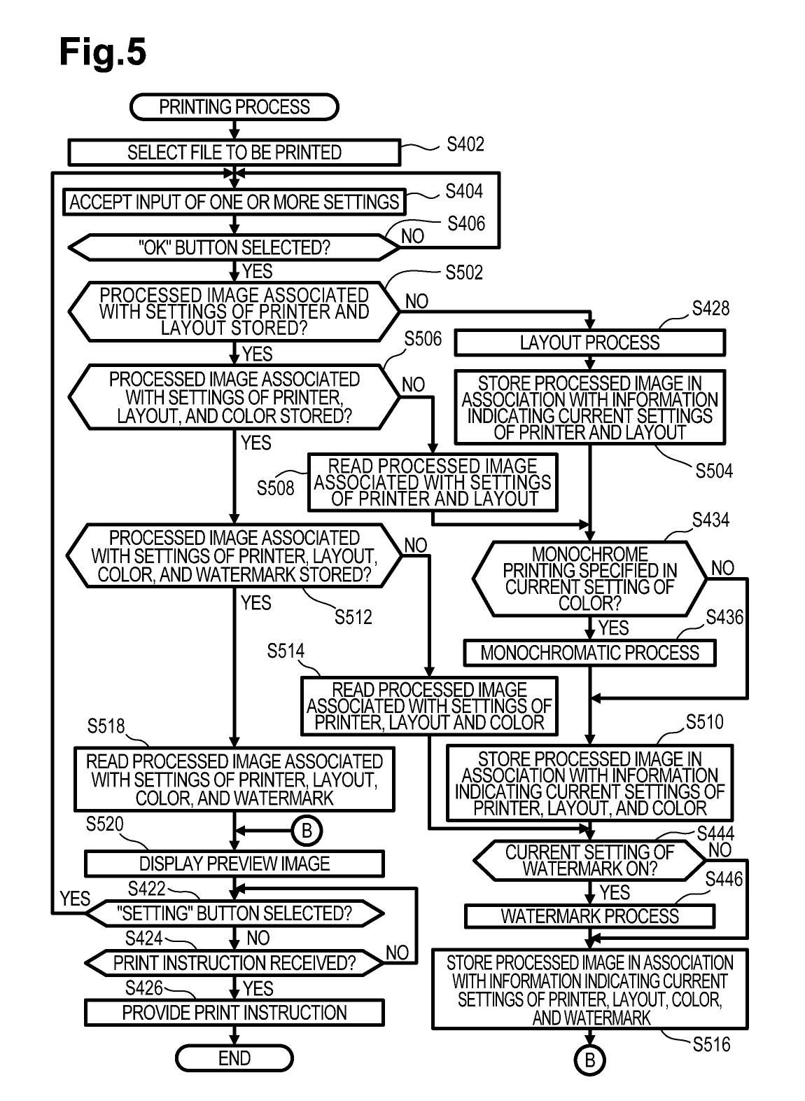

With reference to FIG. 4, a printing process to be executed by the CPU 11 of the mobile terminal 10 in accordance with the device control application 14b will be described. In the printing process, a preview image 43 corresponding to the settings 41 is generated and displayed on the LCD 18. The printing process starts when the user starts the device control application 14b and specifies a desired file to be printed by touching an icon (not shown) representing the file in the mobile terminal 10. The device control application 14b is configured to allow the CPU 11 to perform each step or to use the function of the OS 14a to allow the CPU 11 to perform each step, in flowcharts of FIGS. 4 and 5. Nevertheless, in other embodiments, the OS 14a or other application may allow the CPU 11 to perform some of the steps of the flowcharts of FIGS. 4 and 5 or hardware itself equipped in the mobile terminal 10 may implement some of the steps of the flowcharts of FIGS. 4 and 5 without involvement by the CPU 11.

In step S402 (hereinafter, step will be omitted), the CPU 11 selects a file to be printed specified by the user from the files stored in the file management area 20a. When the file specified by the user is in a format that cannot be processed by the standard function of the mobile terminal 10, for example, PDF format, the CPU 11 may upload the file specified by the user to the conversion server 300. The conversion server 300 may convert the file in PDF format into a format that can be processed by the mobile terminal 10, for example, JPEG format. Then, the CPU 11 may download the converted file in JPEG format from the conversion server 300. In this case, the CPU 11 selects the converted file downloaded from the conversion server 300 as a file to be printed, in S402.

Then, the CPU 11 accepts an input of one or more settings 41 by displaying the setting screen (See FIG. 2) on the LCD 18 (S404). After that, the CPU 11 determines whether the “OK” button 42 on the setting screen has been selected by the user (S406). Until the CPU 11 determines that the “OK” button 42 has been selected by the user (s406:NO), the CPU 11 repeats S404 and S406.

When the CPU 11 determines that the “OK” button 42 has been selected by the user (S406:Yes) and a preview image 43 has not yet been generated for the file to be printed (S408:Yes), the CPU 11 generates a preview image 43 corresponding to the current settings 41. More specifically, the CPU 11 performs one or more appropriate processes of a series of image processing, which comprises a plurality of image processing processes, for example, a layout process (S428), a monochromatic process (S436), and a watermark process (S446), in accordance with the current settings 41, to generate the preview image 43.

First, the CPU 11 performs the layout process (S428). In the layout process, the CPU 11 determines a size of an image to be printed by the selected device 30 such that the image fits on the sheet having the size specified in the current setting 41 of PAPER SIZE, and determines whether the margin 47 is set based on the current setting 41 of PRINTER. More specifically, the device control application 14b prestores a correspondence between models of the devices 30 included in options of the setting 41 of PRINTER and printer types of the devices 30 (inkjet printers or laser printers). When the device 30 specified in the current setting of PRINTER is an inkjet printer with reference to the correspondence, the CPU 11 does not set margin 47 to the image. When the device 30 specified in the current setting 41 of PRINTER is a laser printer, the CPU 11 sets a margin 47 having a predetermined width. The CPU 11 determines the number of page images 48 to be included in one page of a preview image 43 based on the current setting 41 of LAYOUT.

The CPU 11 generates an image, which has the size determined based on the current setting 41 of PAPER SIZE and includes the margin 47 determined based on the current setting 41 of PRINTER, and includes one or more page images 48 determined based on the current setting 41 of LAYOUT, by using a target file (S428). If a file to be printed includes one page of an image, the image is referred to as the target file. If a file to be printed includes a plurality pages of images, an image of the first page of the plurality of pages is referred to as the target file. If N-in-1 printing is specified in the current setting 41 of LAYOUT and “N” indicates two or more, N pages of images counted from the first page, that is, the N pages of images to be printed on the first page of a sheet are referred to as the target file.

The CPU 11 stores the generated image into the processed image storage area 20b (S430). More specifically, the CPU 11 converts the generated image into a file in JPEG format and records the file into the memory card 20. In the first embodiment, an image generated by the layout process is referred to as a first intermediate processed image, e.g., an intermediate image. Hereinafter, a second intermediate processed image and a third processed image will be described. The first to third processed images will be also collectively called a processed image.

In the first and second embodiments, the CPU 11 performs the layout process (S428), the monochromatic process (S436), and the watermark process (S446) in this order in the series of image processing. For example, when a target file including a plurality of pages is arranged in a single page, the CPU 11 performs a reduction process on the target file in the layout process (S428). Because the layout process (S428) is performed first in the series of image processing, the amount of data to be processed in the monochromatic process (S436) can be reduced. In the watermark process (S446), the CPU 11 positions a watermark 49 in the substantially center of the preview image 43. Because the layout process (S428) is performed first in the series of image processing, the location (the substantially center of the preview image 43) of the watermark 49 can be easily determined in the watermark process (S446).

When monochrome printing is specified in the current setting 41 of COLOR (S434:Yes), the CPU 11 performs the monochromatic process on the first intermediate processed image (S436). In the monochromatic process, a monochrome image is generated by calculation of the brightness of color using a RGB value of each pixel constituting the first intermediate processed image. For example, the monochromatic process is implemented by a known algorithm, e.g., an NTSC-system weighted average method. After the CPU 11 generated an image by performing the monochromatic process on the first intermediate processed image, the CPU 11 stores the generated image into the processed image storage area 20b, as a second intermediate processed image, e.g., the intermediate image (S438).

When color printing is specified in the current setting 41 of COLOR (S434:No), the CPU 11 stores the first intermediate processed image into the processed image storage area 20b as a second intermediate processed image (S440).

That is, when monochrome printing is specified in the current setting 41 of COLOR, the CPU 111 stores the image obtained by performing the monochromatic printing (S436) on the first intermediate processed image, into the processed image storage area 20b, as the second intermediate processed image. When color printing is specified in the current setting 41 of COLOR, the CPU 11 stores a copy of the first intermediate processed image as the second intermediate processed image. Alternatively, in other embodiments, information indicating that the first intermediate processed image needs to be used as the second intermediate processed image may be stored in association with the stored first intermediate processed image, e.g., a file name of the first intermediate processed image.

When the current setting 41 of WATERMARK is on (S444:Yes), the CPU 11 performs the watermark process (S446), in which a watermark image, e.g., a text string, specified in the current setting 41 of WATERMARK is arranged in the substantially center of the second intermediate processed image as a watermark 49. When a watermark image is specified in the current setting 41 of WATERMARK, it means that the current setting 41 of WATERMARK is on. When no watermark image is specified in the current setting 41 of WATERMARK, it means that the current setting 41 of WATERMARK is off. Because the watermark process (S446) is performed after the monochromatic process (S436), a watermark 49 in desired color can be easily arranged in the location regardless of whether color printing or monochrome printing is specified in the current setting 41 of COLOR.

The CPU 11 stores the image generated by performing the watermark process on the second intermediate processed image, into the processed image storage area 20b, as a third processed image (S448). When the current setting 41 of WATERMARK is off (S444:No), the CPU 11 stores the second intermediate processed image into the processed image storage area 20b, as a third processed image (S450).

That is, when the current setting 41 of WATERMARK is on, the CPU 111 stores the image obtained by performing the watermark process (S446) on the second intermediate processed image, into the processed image storage area 20b, as the third processed image. When the current setting 41 of WATERMARK is off, the CPU 11 stores a copy of the second intermediate processed image as the third processed image. Alternatively, in other embodiments, information indicating that the second intermediate processed image needs to be used as the third processed image may be stored in association with the stored second intermediate processed image, for example.

The CPU 11 stores the current settings 41, and the printer type of the device 30 specified in the current setting 41 of PRINTER, into the setting storage area 20c (S418). The CPU 11 changes the screen display from the setting screen to the preview screen (See FIG. 3) on the LCD 18 to display the third processed image as a preview image 43 (S420). The third processed image has the size determined based on the current setting 41 of SHEET SIZE. Accordingly, the CPU 11 displays the third processed image as the preview image 43 after reducing or enlarging the third processed image to conform to the size of the display area of the LCD 18.

Through the series of image processing, the preview image 43 (the third processed image), which was generated latest and corresponds to the current settings 41, and the intermediate-processed images (the first and second intermediate processed images) are stored in the processed image storage area 20b. The intermediate-processed images were generated at the respective image processing processes (the layout process, the monochromatic process, and the watermark process) in the series of image processing performed before the latest preview image 43 is generated.

When the CPU 11 determines that the “SETTING” button 46 on the preview screen has been selected by the user (S422:Yes), the routine goes back to S404 and the CPU 11 changes the display screen from the preview screen to the setting screen (See FIG. 2) on the LCD 18 to repeat the steps. That is, when the user requests the change of the current settings 41 after visually confirming the preview image 43 corresponding to the current settings 41, the CPU 11 accepts the change of the current settings 41. More specifically, the CPU 11 sets the settings 41 stored in S418 to the setting screen and displays the current settings 41 on the LCD 18. Then, the CPU 11 changes one or more of the current settings 41 in accordance with the user's operation.

After the CPU 11 changed one or more of the current settings 41 set to the setting screen, when the CPU 11 determines that the “OK” button 42 has been selected by the user (S406:Yes) and determines that the preview image 43 has already been generated with respect to the file to be printed (S408:No), the CPU 11 determines, based on the current settings 41, whether a preview image 43 corresponding to the current settings 41 is displayed after generating the preview image 43 by using the target file or is displayed by using an appropriate processed image stored in the processed image storage area 20b. Detailed descriptions will be made below.

The CPU 11 determines whether margin information of the printer has been changed (S410). More specifically, the CPU 11 obtains the printer type of the device 30 specified in the current setting 41 of PRINTER and determines whether the current printer type is different from the previous printer type (the printer type stored in the setting storage area 20c). When the current printer type is different from the previous printer type, the CPU 11 determines that the margin information of the printer has been changed (S410:Yes). If the current printer type is the same as the previous printer type, the CPU 11 determines that the margin information of the printer has not been changed (S410:No).

When the margin information of the printer has been changed (S410:Yes), the CPU 11 performs the layout process onto the target file (S428). In this case, an image to be generated by the layout process includes the margin 47 corresponding to the current setting 41 of PRINTER. Then, the CPU 11 stores the image obtained by the layout process, into the processed image storage area 20b, as the first intermediate processed image (S430). At that time, the CPU 11 overwrites the currently-generated first intermediate processed image with the previously-stored first intermediate processed image. The CPU 11 performs none, or one or more appropriate processes of the monochromatic process (S436) and the watermark process (S446), on the currently-generated first intermediate processed image, in accordance with the current settings 41, to generate a preview image 43 corresponding to the current settings 41 and then displays the preview image (S420).

When the margin information of the printer has not been changed (S410:No), the CPU 11 determines whether at least one of the current settings 41 of LAYOUT and SHEET SIZE has been changed (S412). When at least one of the current settings 41 of LAYOUT and SHEET SIZE has been changed (S412:Yes), the routine moves to S428 and the CPU 11 generates and displays a preview image 43 by using the target file as in the case where the margin information of the printer has been changed (S410:Yes). The generation of the preview image 43 by using the target file may be more efficient than the generation of the preview image by using the processed image stored in the processed image storage area 20b when the margin information of the printer has been changed, or when at least one of the settings 41 of LAYOUT and SHEET SIZE has been changed.

When the margin information of the printer, and the current settings 41 of LAYOUT and SHEET SIZE have not been changed (S410:NO and S412:No), the CPU 11 displays a preview image 43 corresponding to the current settings 41 by using the processed image stored in the processed image storage area 20b. The term “using the processed image” includes both cases, one of which is a case where the processed image read from the processed image storage area 20b is displayed as a preview image 43 as it is, and another of which is a case where one or more of appropriate image processing processes in the series of image processing are performed on the processed image read from the processed image storage area 20b in order to generate a preview image 43 corresponding to the current settings 41 and the generated preview image 43 is displayed.

When the margin information of the printer, and the current settings 41 of LAYOUT and SHEET SIZE were not been changed (S410:NO and S412:No) but the current setting 41 of COLOR has been changed (S414:Yes), the CPU 11 reads the first intermediate processed image of the target file, i.e., the target file obtained by the layout process, from the processed image storage area 20b (S432).

Then, the CPU 11 determines whether monochrome printing is specified in the changed setting 41 (the current setting 41) of COLOR (S434). When color printing was specified in the previous setting 41 of COLOR and monochrome printing is now specified in the current setting 41 of COLOR (S434:Yes), the CPU 11 performs the monochromatic process on the first intermediate processed image read in S432 (S436) and stores the generated image into the processed image storage area 20b as the second intermediate processed image (S438). At that time, the CPU 11 overwrites the previously-stored second intermediate processed image with the currently-obtained second intermediate processed image.

When monochrome printing was specified in the previous setting 41 of COLOR and color printing is specified in the current setting 41 of COLOR (S434:No), the CPU 11 stores the first intermediate processed image into the processed image storage area 20b as the second intermediate processed image without performing the monochromatic process onto the first intermediate processed image read in S432 (S440). At that time, the CPU 11 overwrites the previously-stored second processing image with the currently-obtained first intermediate processed image as the updated second intermediate processed image.

When the current setting 41 of WATERMARK is on (S444:Yes), the CPU 11 performs the watermark process on the second intermediate processed image (S446). Then, the CPU 11 stores the image generated by performing the watermark process on the second intermediate processed image, into the processed image storage area 20b, as the third processed image (S448). At that time, the CPU 11 overwrites the previously-stored third processed image with the currently-generated third processing image.

When the current setting 41 of WATERMARK is off (S444:No), the CPU 11 stores the second intermediate processed image as the third processed image without performing the watermark process onto the second intermediate processed image. At that time, the CPU 11 overwrites the previously-stored third processed image with the second intermediate processed image to be currently-processed as the updated third processed image. The CPU 11 displays the third processed image on the LCD 18 as a preview image 43 (S420).

By doing so, when only the current setting 41 of COLOR has been changed, the CPU 11 can generate the preview image 43 corresponding to the current settings 41 by omitting the layout process (S428) without the need to use the target file. Accordingly, the CPU 11 can immediately display the preview image 43 corresponding to the current settings 41 on the LCD 18.

When the margin information of the printer, and the current settings 41 of LAYOUT, SHEET SIZE, and COLOR have not been changed (S410:No, S421:No, and S414:No) but the current setting 41 of WATERMARK has been changed (S416:Yes), the CPU 11 reads the second intermediate processed image, i.e., the image on which the watermark process has not been performed yet, among the processed images of the target file (S442).

When the current setting 41 of WATERMARK is on (S444:Yes), the CPU 11 positions a watermark 49 indicating the watermark image specified in the current setting 41 of WATERMARK in the substantially center of the second intermediate processed image read in S442 (S446).

The CPU 11 stores the image generated by performing the watermark process on the second intermediate processed image, into the processed image storage area 20b, as the third processed image (S448). At that time, the CPU 11 overwrites the previously-stored third processed image with the newly-generated third processed image.

When the current setting 41 of WATERMARK is off (S444:No), the CPU 11 stores the second intermediate processed image read in S442, into the processed image storage area 20b (S450). At that time, the CPU 11 overwrites the previously-stored third processed image with the currently-obtained second intermediate processed image, as the updated third processed image.

The CPU 11 displays the third processed image as a preview image 43 on the LCD 18 (S420). By doing so, when only the current setting 41 of WATERMARK has been changed, the CPU 11 can generate the preview image 43 corresponding to the current settings 41 by using the second intermediate processed image by omitting the layout process (S428) and the monochromatic process (S436) without the need to use the target file. Accordingly, the CPU 11 can immediately display the preview image 43 corresponding to the current settings 41 on the LCD 18.

When the margin information of the printer, and the current settings 41 of LAYOUT, SHEET SIZE, COLOR, and WATERMARK have not been changed (S410:No, S412:No, S414:No, and S416:No), the CPU 11 reads the image stored in the processed image storage area 20b as the third processed image therefrom and displays the read image as it is on the LCD 18 as the preview image 43 (S420). That is, although the setting 41 whose change does not influence the preview image 43, for example, one or more of the settings 41 of MEDIA TYPE and NUMBER OF COPIES have been changed, the third processed image, on which one or more appropriate processes of the series of the image processing have been performed with the same setting options (also referred to herein as “details”) as the setting options indicated by the changed settings 41, is stored in the processed image storage area 20b. Therefore, the CPU 11 reads the third processed image from the processed image storage area 20b and displays the read third processed image on the LCD 18 as the preview image 43. As a result, the CPU 11 can immediately display the preview image 43 corresponding to the current settings 41 on the LCD 18.

When the CPU 11 determines that the “SETTING” button 46 has not been selected by the user (S422:No) and a print instruction has not been received (S424:No), the CPU 11 repeats S422. On the other hand, when the CPU 11 determines that a print instruction has been received from the user who touched the “PRINT” button 45 (S424:Yes), the CPU 11 provides the device 30 specified in the current setting 41 of PRINTER with an instruction to print the third processed image, i.e., the image on which one or more appropriate processes of the series of image processing have been performed with the details indicated by the settings 41 (S426) and then ends the printing process. The processed images stored in the memory card 20 may be maintained while the device control application 14b is running and may be erased therefrom when the device control application 14b is ended.

According to the printing process of the first embodiment, only when the change of one or more of the settings 41 influences the preview image 43, the CPU 11 performs one or more appropriate processes of the series of image processing on the target file or the appropriate processed image to generate an updated preview image 43. Accordingly, the generation of the preview image 43 can be minimized and thus this may result in increasing efficiency of the generation of the preview image 43.

When one or more of the settings 41 have been changed, the CPU 11 generates an updated preview image 43 corresponding to the current settings 41 by using the appropriate processed image stored in the processed image storage area 20b in some cases. Therefore, the updated preview image 43 corresponding to the current settings 41 can be immediately displayed as compared with a case where an updated preview image 43 is generated by using the target file. Such an effect may be brought to the fore in a device having a lower performance, e.g., the mobile terminal 10. Even when a format of a file to be printed needs to be converted by uploading the file to the conversion server 300 because the mobile terminal 10 cannot process the file in the current format, e.g., PDF format, it is unnecessary to upload the file every time one or more of the settings 41 are changed according to the printing process of the first embodiment. Accordingly, an improvement may be obtained in the speed of the display of the preview image 43.

In the processed image storage area 20b, as well as the latest preview image 43, the first and second intermediate processed images, which had been generated at the respective image processing processes of the series of the image processing performed before the latest preview image 43 was generated, are stored as the processed images of the target file. Accordingly, the CPU 11 can immediately display the preview image 43 corresponding to the current settings 41 on the LCD 18 by using the appropriate processed image corresponding to the current settings 41.

For example, when the current setting 41 of COLOR has been changed, the CPU 11 reads the first intermediate processed image, which was generated by the layout process (S428) performed just prior to the monochromatic process (S436) corresponding to the setting 41 of COLOR. Similar to this, when the setting 41 of WATERMARK has been changed, the CPU 11 reads the second intermediate processed image, which was generated just prior to the watermark process (S446) corresponding to the setting 41 of WATERMARK.

That is, the CPU 11 reads the processed image, on which one or more appropriate processes of the series of image processing have already been performed with the same details as the details indicated by the current settings 41, beginning with the first image processing process of the series of image processing in accordance with the sequence of performance. Then, the CPU 11 omits one or more appropriate processes that have already been performed on the read processed image, and performs the rest of the yet-to-be performed image processing processes of the series of image processing on the read processed image with the same details as the details indicated by the current settings 41, beginning with the process to be performed next in the sequence. By doing so, the CPU 11 generates an updated preview image 43. Accordingly, the CPU 11 requires less time to generate and display the updated preview image 43 by using the processed image of the target file than the CPU 11 generates the update preview image 43 by using the target file itself.

According to the printing process shown in FIG. 4, the CPU 11 reads the processed image that is nearly the same as an updated preview image 43 corresponding to the current settings 41. For example, the first intermediate processed image and the second intermediate processed image may be stored as the processed images on which one or more intermediate processes of the series of image processing have already been performed with the details that are the same as the details indicated by the current settings 41, respectively. In this case, the CPU 11 uses the second intermediate processed image, i.e., the processed image on which more processes have already been performed with the details that are the same as the details indicated by the current settings 41. Accordingly, the CPU 11 can omit more appropriate processes as much as possible and generate an updated preview image more immediately.

With reference to FIG. 5, a printing process to be executed by the CPU 11 in accordance with the device control application 14b according to a second embodiment will be described below. In FIG. 4 according to the first embodiment and FIG. 5 according to the second embodiment, the same steps are labeled with the same reference numerals and description for these same steps will be omitted in the second embodiment.

In the printing process according to the first embodiment, one each of the first intermediate processed image, the second intermediate processed image, and the third processed image are stored in the processed image storage area 20b. Alternatively, in the printing process according to the second embodiment, every time an updated preview image 43 is generated, a processed image corresponding to the updated preview image 43 and an intermediate processed image generated at each image processing process until the processed image corresponding to the updated preview image 43 is generated, are separately stored in the processed image storage area 20b. According to the second embodiment, each processed image is stored in the processed image storage area 20b in association with associated information that indicates one or more image processing processes performed on the processed image.

The CPU 11 determines whether the processed image associated with the settings of PRINTER and LAYOUT is stored in the processed image storage area 20b (S502). When the processed image associated with the settings of PRINTER and LAYOUT is not stored (S502:No), the CPU 11 performs the layout process with the details indicated by the current settings 41 (S428). In the first embodiment, the CPU 11 determines whether the margin 47 is set in accordance with the printer type indicated by the current setting 41 of PRINTER. In the second embodiment, however, the device control application 14b prestores margins set for every models of the devices 30 included in the options to be specified in the setting 41 of PRINTER. In the layout process (S428), the CPU 11 sets a margin 47 corresponding to the current setting 41 of PRINTER to the processed image.

The CPU 11 stores the processed image generated by the layout process into the processed image storage area 20b and adds information indicating the current settings 41 of PRINTER and LAYOUT to the file name of the processed image, i.e., information that indicates the image processing process performed on the processed image is associated to the file (S504). In the second embodiment, a newly-generated processed image is additionally stored in the processed image storage area 20b while the previously-stored processed images are maintained as they are but are not overwritten with the newly-generated processed image.

When monochrome printing is specified in the current setting 41 of COLOR, the CPU 11 performs the monochromatic process (S436) on the processed image on which the layout process has already been performed in S428. Then, the CPU 11 stores the processed image generated by the monochromatic process into the processed image storage area 20b in association with information that indicates the image processing processes performed on the processed image, as well as information that indicates the current settings 41 of PRINTER, LAYOUT, and COLOR, to the file name of the processed image.

When monochrome printing is not specified in the current setting 41 of COLOR (S434:No), the CPU 11 stores a copy of the processed image, which was stored in S504, into the processed image storage area 20b in association with the information that indicates the image processing processes performed on the processed image, as well as information that indicates the current settings 41 of PRINTER, LAYOUT, and COLOR, to the file name of the copy of the processed image (S510). That is, the image is the same as each other but the file name is different from each other between the processed image stored in S504 and the processed image stored in S510.

When the current setting 41 of WATERMARK is on (S444:Yes), the CPU 11 reads the processed image, which was stored in S510, and performs the watermark process (S446).

Then, the CPU 11 stores the processed image, on which the watermark process has been performed, into the processed image storage area 20b in association with information that indicates the image processing processes performed on the processed image, as well as information that indicates the current settings 41 of PRINTER, LAYOUT, COLOR, and WATERMARK, to the file name of the processed image (S516).

When the current setting 41 of WATERMARK is off (S444:No), the CPU 11 stores a copy of the processed image stored in S510 into the processed image storage area 20b, in association with information that indicates the image processing processes performed on the processed image, as well as information that indicates the current settings 41 of PRINTER, LAYOUT, COLOR, and WATERMARK, to the file name of the copy of the processed image (S516). In this case, the image is the same as each other but the file name is different from each other between the processed image stored in S510 and the processed image stored in S516.

The CPU 11 displays the processed image, which was stored in the processed image storage area 20b in S516, on the LCD 18, as a preview image 43 (S520). When the CPU 43 determines that the “SETTING” button 46 has been selected (S422:Yes), the CPU 11 changes the display screen from the preview image 43 to the setting screen on the LCD 18. The CPU 11 changes the settings 41 set in the setting screen in accordance with the user's operation (S404).

The CPU 11 determines whether at least one processed image, which is associated with the same settings as the changed settings 41 (the current settings 41) of PRINTER and LAYOUT, is stored in the processed image storage area 20b (S502). When the processed image associated with the same settings is not stored (S502:No), the routine moves to S428 and the CPU 11 generates an updated preview image 43 by using the target file and displays the updated preview image 43 on the LCD 18.

When at least one processed image, which is associated with the same settings as the changes settings 41 of PRINTER and LAYOUT, is stored in the processed image storage area 20b (S502:Yes), the CPU 11 displays an updated preview image 43 corresponding to the changed settings 41 on the LCD 18 by using the processed image.

More specifically, when at least one processed image, which is associated with the same settings as the current settings 41 of PRINTER and LAYOUT (S502:Yes) but not the current setting 41 of COLOR (S506:No), is stored in the processed image storage area 20b, the CPU 11 reads the processed image, which is associated with the current settings 41 of PRINTER and LAYOUT, from the processed image storage area 20b (S508). At that time, there are at least three processed images that satisfy the criteria, i.e., the processed image stored in S504, the processed image stored in S510, and the processed image stored in S516, stored in the processed image storage area 20b.

In S508, the CPU 11 reads the processed image stored in S504, i.e., the processed image that is not associated with the setting 41 of COLOR, among the three types of the processed images. Then, the CPU 11 omits or performs one or more appropriate processes of the monochromatic process (S436) and the watermark process (S466) on the read processed image. By doing so, the CPU 11 generates and displays an updated preview image 43 corresponding to the current settings 41 (S520). In this case, the CPU 11 can omit the layout process (S428) and immediately display the updated preview image 43 corresponding to the current settings 41.

When at least one processed image, which is associated with the same settings as the current settings 41 of PRINTER, LAYOUT, and COLOR (S502:Yes and S506:Yes) but not the current setting 41 of WATERMARK (S512:No) is stored in the processed image storage area 20b, the CPU 11 reads the processed image associated with the settings 41 of PRINTER, LAYOUT and COLOR from the processed image storage area 20b (S514). At that time, there are at least two processed images that satisfy the criteria, i.e., the processed image stored in S510, and the processed image stored in S516, stored in the processed image storage area 20b.

In S514, the CPU 11 reads the processed image stored in S510, i.e., the processed image that is not associated with the setting 42 of WATERMARK, from the two types of the processed images. The CPU 11 generates and displays an updated preview image 43 corresponding to the current settings 41 by using the read processed image (S520). By doing so, the CPU 11 can omit the layout process (S428) and the monochromatic process (S436) and immediately display the updated preview image 43 corresponding to the current settings 41.

When the processed image, which is associated with the same settings as the current settings 41 of PRINTER, LAYOUT, COLOR and WATERMARK, is stored in the processed image storage area 20b (S502:Yes, S506:Yes, and S512:Yes), the CPU 11 reads the applicable processed image, i.e., the processed image associated with the settings 41 of PRINTER, LAYOUT, COLOR and WATERMARK, from the processed image storage area 20b (S518), and displays the read processed image as an updated preview image 43 (S520). By doing so, the CPU 11 can omit all of the image processing processes of the series of the image processing to be performed to generate an updated preview image 43 and immediately display the updated preview image 43 corresponding to the current settings 41.

According to the printing process of the second embodiment, the information indicating one or more image processing processes performed on the processed image is associated with the file name of the processed image. Therefore, the CPU 11 can immediately display an updated preview image 43 corresponding to the current settings 41 by using an appropriate processed image of the target file.

In the above-described embodiments, the mobile terminal 10 is an example of an image forming device. The devices 30 are an example of a printing device. The setting 41 of PRINTER is an example of a printing portion setting. The file name is an example of associated information.

The LCD 18 is an example of a display portion. The memory card 20 is an example of a storage portion. The storage portion may be an internal memory equipped in the mobile terminal 10, e.g., the flash memory 14.

The CPU 11 that performs the processing of S404 is an example of a setting unit. The CPU 11 that performs the processing of S410, S412, and S502 is an example of a determining unit. The CPU 11 that performs the processing of S428-S450 is an example of a generating unit. The CPU 11 that performs the processing of S420 and S520 is an example of a first display control unit and an example of a second display control unit. The CPU 11 that performs the processing of S430, S438, S440, S448, S450, S504, S510, and S516 is an example of a storage control unit. The CPU 11 that performs the processing of S432, S442, S508, and S514 is an example of a processed image obtaining unit. In the second embodiment, the CPU 11 that performs the processing of S428, S434, S436, S444, and S446 is a generating unit. The CPU 11 that performs the processing of S434, S436, S444, and S446 is an example of regenerating unit. The LCD 18 operated by the control of the CPU 11 is an example of a first display device and an example of a second display device. The memory card I/F 19 operated by the control of the CPU 11 is an example of a storage unit.

In the above-described embodiments, the mobile terminal 10 having a telephone function is an example of the image processing device. However, other devices that do not have the telephone function, for example, personal computers or digital cameras, may be an example of the image processing device.

In the above-described embodiments, a file in JPEG format is an example of a file format that can be processed by the standard function of the mobile terminal 10. However, the file format is not limited to JPEG format. Other formats, for example, PNG format, GIF format, and BMP format, may also be applicable to the file format that can be processed in the mobile terminal 10.

In the above-described embodiments, a file in PDF format is an example of a file format that cannot be processed in the mobile terminal 10. However, the file format is not limited to PDF format. Other formats, for example, DOC format and XLS format, may also be applicable to the file format that cannot be processed in the mobile terminal 10.

In the above-described embodiments, the layout process, the monochromatic process, and the watermark process are examples of the image processing processes of the image processing. Nevertheless, in other embodiments, for example, other image processing processes, e.g., brightness adjustment process or contrast adjustment process, may be performed in addition to or instead of the image processing processes performed in the above-described embodiments.

In the above-described embodiments, the CPU 11 determines whether to generate a preview image 43 by using the target file or by using the processed image of the target file stored in the memory card 20, in accordance with the current settings 41, without the user's intention. Nevertheless, in other embodiments, the CPU 11 may perform the determination in accordance with the user's selecting operation, for example.

In the above-described embodiments, the CPU 11 generates a processed image having a size determined based on a setting of SHEET SIZE, i.e., an image having an actual size to be printed by a selected device 30, and displays the processed image as a preview image 43 after reducing or enlarging the processed image in size. Nevertheless, in other embodiments, for example, the CPU 11 may generate a processed image having a size of a preview image 43, store the generated processed image in the processed image storage area 20b, and use the stored processed image, in addition to or instead of the processed image according to the above-described embodiments.

In the first embodiment, the printer type is the information that indicates either one of the inkjet printer and the laser printer. Nevertheless, in other embodiments, for example, the printer type may be information that indicates any one of a serial printer, a line printer, and a page printer or information indicating a manufacturer of each device 30.

In the above-described embodiments, when a file to be printed includes a plurality of pages of images, the CPU 11 generates a preview image 43 by using a target file, which includes the first page of an image or N pages of images counted from the first page. Nevertheless, in other embodiments, the printing process may be modified such that the user can arbitrarily determine one or more pages to be used as the target file.

In the above-described embodiments, the mobile terminal 10 is configured to access the Internet 200 via the mobile phone network 100 by the telephone network communication portion 22. Alternatively, in other embodiments, the mobile terminal 10 may be configured to access the Internet 200 via the access point 50 by the wireless LAN transmitting/receiving portion 15 for saving the communication cost.

While the invention has been described in detail with reference to the specific embodiments thereof, it would be apparent to those skilled in the art that various changes, arrangements and modifications may be applied therein without departing from the spirit and scope of the invention.

What is claimed is:

1. An image processing device comprising:
a processor; and
a memory storing computer readable instructions that, when executed, cause the image processing device to perform functions comprising:
specifying a setting related to printing;
generating a first processed image by using a target file by performing image processing corresponding to the specified setting;
storing the first processed image;
displaying the first processed image;
displaying, when the setting is changed, a second processed image that is generated from image processing of the first processed image and corresponds to the changed setting.

2. The image processing device according to claim 1, wherein the functions further comprise:
when the setting is changed, determining whether to generate and display the first processed image corresponding to the changed setting by using the target file or to generate and display the second processed image corresponding to the changed setting by using the first processed image.

3. The image processing device according to claim 1, further comprising:
a storage portion configured to store a plurality of first processed images generated with respect to the target file,
wherein the functions further comprise:
reading an appropriate one of the first processed images from the storage portion based on the changed setting, and
displaying the second processed image corresponding to the changed setting by using the appropriate processed image read from the storage portion.

4. The image processing device according to claim 3, wherein the functions further comprise:
reading the processed image, on which the image processing has already been performed with a setting option that is the same as the setting option indicated by the changed setting, from the storage portion, as the appropriate processed image; and
using the read appropriate processed image to display the second processed image corresponding to the changed setting.

5. The image processing device according to claim 3, wherein the functions further comprise:
generating the second processed image corresponding to the changed setting by using the appropriate processed image; and
using the read appropriate processed image to display the second processed image.

6. The image processing device according to claim 5, wherein the image processing is a series of image processing comprising a plurality of image processing processes whose sequence of performance is predetermined,
wherein the setting comprises a plurality of settings that indicate setting options of the plurality of image processing processes, respectively, of the series of image processing,
wherein the functions further comprise:
generating the first processed image by using the target file by performing one or more of the plurality of image processing processes of the series of image processing in accordance with the setting options indicated by the plurality of settings;
reading the appropriate processed image, on which one or more of the plurality of image processing processes have already been performed with the same setting options as the setting options indicated by the changed setting, beginning with the first image processing process in the series of image processing in accordance with the sequence of performance; and
generating the second processed image by omitting appropriate one or more of the plurality of image processing processes that have already been performed on the appropriate processed image and performing the rest of the plurality of image processing processes that has not been performed on the appropriate processed image, with the same setting options as the setting options indicated by the changed setting, beginning with the process to be performed next in the sequence.

7. The image processing device according to claim 6, wherein the functions further comprise:
reading the appropriate processed image, on which more image processing processes of the plurality of image processing processes have been performed with the setting options that are the same as the setting options indicated by the changed setting, from the storage portion, when the plurality of first processed images of the target file are stored in the storage portion,
wherein one or more of the plurality of image processing processes have already been performed on each of the plurality of first processed images with the same setting options as the setting options indicated by the changed settings from the first image processing process in the series of image processing in accordance with the sequence of performance.

8. The image processing device according to claim 6, wherein the functions further comprise:
storing at least one of the first processed image, which is generated latest by using the target file, and the second processed image, which is generated latest by using the appropriate processed image, and intermediate-processed images, each of which is generated at each image processing process of the series of image processing that has been performed before the latest processed image is generated, into the storage portion as the plurality of first processed images of the target file; and
reading an appropriate one of the intermediate-processed images when one or more of the plurality of settings are changed, wherein the appropriate intermediate-processed image was generated by one of the plurality of image processing processes immediately prior to the image processing process corresponding to one or more of the plurality of changed settings and is stored in the storage portion as one of the plurality of first processed images.

9. The image processing device according to claim 5, wherein the function further comprise:
storing at least one of the first processed image and second processed images every time the first processed image is generated by using the target file or the second processed image is generated by using the appropriate processed image, with associated information that indicates one or more of the image processing processed performed on the first or second processed image; and
reading the appropriate one of the first and second processed images stored in the storage portion, based on the associated information.

10. The image processing device according to claim 2, wherein the setting includes a printing portion setting that indicates a printing device to which a print instruction is provided, and
wherein the functions comprise determining, when the printing portion setting is changed, that the first processed image corresponding to the changed setting is generated and displayed by using the target file.

11. The image processing device according to claim 2,
wherein the setting includes a printing portion setting that indicates a printing device to which a print instruction is provided, and
wherein the functions further comprise:
determining, when the printing portion setting is changed and a type of the printing device specified in the printing device setting is different between before and after the printing device setting was changed, that the first processed image corresponding to the changed setting is generated and displayed by using the target file.

12. A non-transitory, computer-readable medium storing an information processing program that, when executed by a processor, causes an information processing device to execute steps of comprising:
specifying a setting related to printing;
generating a first processed image by using a target file by performing image processing corresponding to the specified setting;
storing the first processed image;
displaying the first processed image;
displaying, when the setting is changed, a second processed image that is generated from image processing of the first processed image and corresponds to the changed setting.

13. The non-transitory, computer-readable medium storing the information processing program according to claim 12, wherein the steps further comprise:
when the setting is changed, determining whether to generate and display the first processed image corresponding to the changed setting by using the target file or to generate and display the second processed image corresponding to the changed setting by using the first processed image.

14. The non-transitory, computer-readable medium storing the information processing program according to claim 12, wherein the information processing device includes a storage portion configured to store a plurality of first processed images generated with respect to the target file,
wherein the steps further comprise:
reading an appropriate one of the first processed images from the storage portion based on the changed setting, and
displaying the second processed image corresponding to the changed setting by using the appropriate processed image read from the storage portion.

15. The non-transitory, computer-readable medium storing the information processing program according to claim 14, wherein the steps further comprise:
reading the processed image, on which the image processing has already been performed with a setting option that is the same as the setting option indicated by the changed setting, from the storage portion, as the appropriate processed image; and
using the read appropriate processed image to display the second processed image corresponding to the changed setting.

16. The non-transitory, computer-readable medium storing the information processing program according to claim 14, wherein the steps further comprise:
generating the second processed image corresponding to the changed setting by using the appropriate processed image; and
using the read appropriate processed image to display the second processed image.

17. The non-transitory, computer-readable medium storing the information processing program according to claim 16,
wherein the image processing is a series of image processing comprising a plurality of image processing processes whose sequence of performance is predetermined,
wherein the setting comprises a plurality of settings that indicate setting options of the plurality of image processing processes, respectively, of the series of image processing,
wherein the steps further comprise:
generating the first processed image by using the target file by performing one or more of the plurality of image processing processes of the series of image processing in accordance with the setting options indicated by the plurality of settings;
reading the appropriate processed image, on which one or more of the plurality of image processing processes have already been performed with the same setting options as the setting options indicated by the changed setting, beginning with the first image processing process in the series of image processing in accordance with the sequence of performance; and
generating the second processed image by omitting appropriate one or more of the plurality of image processing processes that have already been performed on the appropriate processed image and performing the rest of the plurality of image processing processes that has not been performed on the appropriate processed image, with the same setting options as the setting options indicated by the changed setting, beginning with the process to be performed next in the sequence.

18. The non-transitory, computer-readable medium storing the information processing program according to claim 17,
wherein the steps further comprise:
reading the appropriate processed image, on which more image processing processes of the plurality of image processing processes have been performed with the setting options that are the same as the setting options indicated by the changed setting, from the storage portion, when the plurality of first processed images of the target file are stored in the storage portion,
wherein one or more of the plurality of image processing processes have already been performed on each of the plurality of first processed images with the same setting options as the setting options indicated by the changed settings from the first image processing process in the series of image processing in accordance with the sequence of performance.

19. The non-transitory, computer-readable medium storing the information processing program according to claim 17, wherein the steps further comprise:
storing at least one of the first processed image, which is generated latest by using the target file, and the second processed image, which is generated latest by using the appropriate processed image, and intermediate-processed images, each of which is generated at each image processing process of the series of image processing that has been performed before the latest processed image is generated, into the storage portion as the plurality of first processed images of the target file; and
reading an appropriate one of the intermediate-processed images when one or more of the plurality of settings are changed, wherein the appropriate intermediate-processed image was generated by one of the plurality of image processing processes immediately prior to the image processing process corresponding to one or more of the plurality of changed settings and is stored in the storage portion as one of the plurality of first processed images.

20. The non-transitory, computer-readable medium storing the information processing program according to claim 16, wherein the steps further comprise:
storing at least one of the first processed image and second processed images every time the first processed image is generated by using the target file or the second processed image is generated by using the appropriate processed image, with associated information that indicates one or more of the image processing processed performed on the first or second processed image; and
reading the appropriate one of the first and second processed images stored in the storage portion, based on the associated information.

21. The non-transitory, computer-readable medium storing the information processing program according to claim 13,
wherein the setting includes a printing portion setting that indicates a printing device to which a print instruction is provided, and
wherein the steps comprise determining, when the printing portion setting is changed, that the first processed image corresponding to the changed setting is generated and displayed by using the target file.

22. The non-transitory, computer-readable medium storing the information processing program according to claim 13,
wherein the setting includes a printing portion setting that indicates a printing device to which a print instruction is provided, and
wherein the steps comprise determining, when the printing portion setting is changed and a type of the printing device specified in the printing device setting is different between before and after the printing device setting was changed, that the first processed image corresponding to the changed setting is generated and displayed by using the target file.

23. An information processing method to be executed in an image forming device, comprising steps of:
specifying a setting related to printing;
generating a first processed image by using a target file by performing image processing corresponding to the specified setting;
storing the first processed image;
displaying the first processed image;
displaying, when the setting is changed, a second processed image that is generated from image processing of the first processed image and corresponds to the changed setting.
